(19) United States
(12) Patent Application Publication
(10) Pub. No.: US 2012/0146265 A1
(43) Pub. Date: Jun. 14, 2012

(54) INTERMEDIATE TRANSFER MEMBER METHOD OF MANUFACTURE

(75) Inventor: Jin Wu, Pittsford, NY (US)

(73) Assignee: XEROX CORPORATION, Norwalk, CT (US)

(21) Appl. No.: 12/967,710

(22) Filed: Dec. 14, 2010

(51) Int. Cl. B29C 35/08

(52) U.S. Cl. 264/463

(57) ABSTRACT

Described herein is a method of forming an intermediate transfer member suitable for use in an image forming system. The method includes providing a mixture of an ultra violet (UV) curable polymer, a conductive component and a photoinitiator. The mixture is centrifugally molded onto an inner surface of a rotating cylindrical mandrel. The UV polymer is cured with ultra violet energy and removed from the cylindrical rotatable mold.

### CROSS REFERENCE TO RELATED APPLICATIONS

This application relates to commonly assigned copending application Ser. No. 12/624,589, filed Nov. 24, 2009, and entitled “UV Cured Heterogeneous Intermediate Transfer Belts (ITB),” and Ser. No. 12/731,449, filed Mar. 25, 2010, and entitled “Intermediate Transfer Belts,” which are hereby incorporated by reference in their entireties.

### BACKGROUND

1. Field of Use

This disclosure is directed to an image forming apparatus and an intermediate transfer member and a method of manufacture of the intermediate transfer member.

2. Background

In the printing industry many of the current flexible photoreceptor belts (P/R) or intermediate transfer belts are obtained by shearing a piece of web material coated with several layers of an organic material with desired electrical and mechanical properties and welding the two ends together in a variety of ways such as electro-welding. The seam present in the intermediate transfer belts creates certain issues. One issue is the need to avoid the seam coming into a printed area. Seam detection and managing the duty cycles for various paper lengths is a complicated software and technology challenge. Due to their expense, seamless belts have been used predominantly for large machines.

Seamless P/R and intermediate transfer belts, especially for smaller low volume printers, would be useful. For color machine architecture, a seamless intermediate transfer belt would reduce the size of a full color machine.

Centrifugal molding is used to obtain seamless polyimide belts useful as intermediate transfer members. Typically, a thin fluorine or silicone release layer is applied to the inner surface of a rigid cylindrical mandrel. A polyimide coating is applied to the inner surface of the mandrel containing the release layer. The polyimide is cured and then released from the mandrel. U.S. Pat. Nos. 5,389,412, 6,001,440, 6,139,784 disclose the process of preparing polyimide seamless ITB by centrifugal molding followed by thermal curing; while U.S. Pat. No. 5,021,036 discloses the process of preparing polycarbonate seamless ITB by centrifugal molding followed by thermal curing.

In U.S. Pat. No. 6,500,367, a method of manufacturing a seamless ITB is described in which multiple layers of liquid polymer are applied to a rotating mold and cured at an elevated temperature.

There are drawbacks to the processes disclosed above. The length of the polyimide belt is determined by the size of the mandrel. The requirement of a release layer on the inner surface of the mandrel is an additional process step.

### SUMMARY

Described herein is a method of forming an intermediate transfer member suitable for use in an image forming system. The method includes providing a mixture of an ultra violet (UV) curable polymer, a conductive component and a photoinitiator. The mixture is centrifugally molded onto an inner surface of a rotating cylindrical mandrel. The UV polymer is cured with ultra violet energy and removed from the cylindrical rotatable mold.

Described herein is a method of forming a seamless transfer member suitable for use with an image forming system. The method includes providing a mixture of an ultra violet (UV) curable polymer, conductive particles and a photoinitiator. The mixture is centrifugally molded on an inner surface of a rotating mandrel at a speed of from about 100 rpm to about 1500 rpm. The inner surface of the mandrel has an average roughness of from about 0.01 microns to about 1.0 microns. The mixture is cured with ultraviolet energy and removed the cylindrical rotatable mold.

Described herein is a method of forming a seamless transfer member suitable for use with an image forming system. The method includes providing a mixture of an ultra violet (UV) curable polymer, carbon nanotubes, and a photoinitiator. The mixture is centrifugally molding the mixture on an inner surface of a rotating mandrel at a speed of from about 100 rpm to about 1500 rpm. The inner surface of the mandrel has an average roughness of from about 0.01 microns to about 1.0 microns. The mixture is cured with ultraviolet energy and removed from the cylindrical rotatable mold.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic illustration of an image apparatus.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

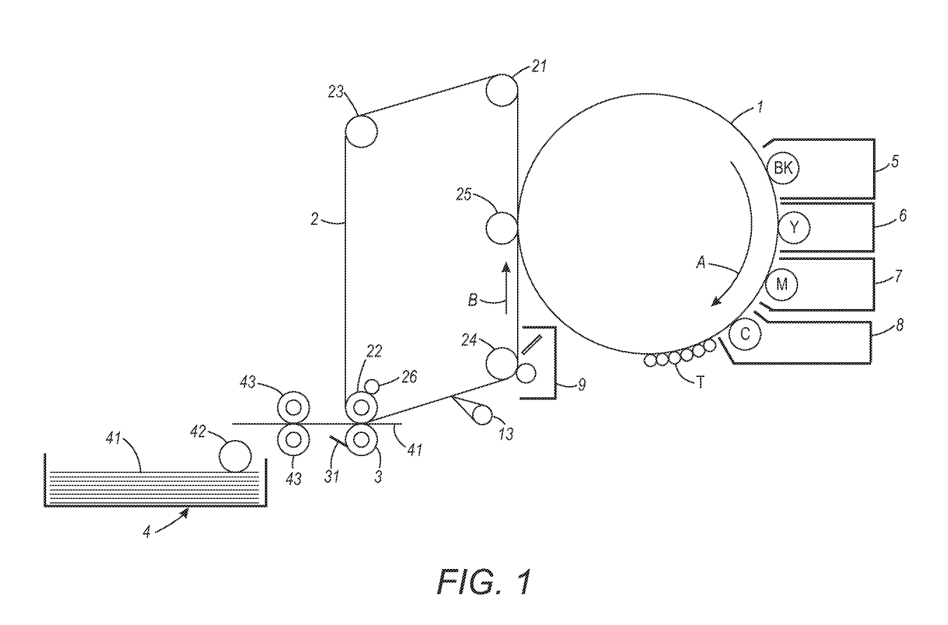

Referring to FIG. 1, an image forming apparatus includes an intermediate transfer member as described in more detail below. The image forming apparatus is an intermediate transfer system comprising a first transfer unit for transferring the toner image formed on the image carrier onto the intermediate transfer member by primary transfer, and a second transfer unit for transferring the toner image transferred on the intermediate transfer member onto the transfer material by secondary transfer. Also, in the image forming apparatus, the intermediate transfer member may be provided as a transfer-conveying member in the transfer region for transferring the toner image onto the transfer material. Having an intermediate transfer belt that transfers images of high quality and remains stable for a long period is required.

The image forming apparatus described herein is not particularly limited as far as it is an image forming apparatus of intermediate transfer type. Examples include an ordinary monochromatic image forming apparatus accommodating only a monochromatic color in the developing device, a color image forming apparatus for repeating primary transfer of the toner image carried on the image carrier sequentially on the intermediate transfer member, and a tandem color image forming apparatus having plural image carriers with developing units of each color disposed in series on the intermediate transfer member. More specifically, the image forming apparatus may arbitrarily comprise an image carrier, a charging unit for uniformly charging the surface of the image carrier, an exposure unit for exposing the surface of the intermediate transfer belt and forming an electrostatic latent image, a developing unit for developing the latent image formed on the surface of the image carrier by using a developing solution and forming a toner image, a fixing unit for fixing the toner unit on the transfer material, a cleaning unit for removing toner and foreign matter sticking to the image carrier, a destaticizing unit for removing the electrostatic latent image left over on the surface of the image carrier, and other known methods as required.

As the image carrier, a known one may be used. As the image carrier's photosensitive layer, an organic system, amorphous silicon, or other known material may be used. In the case of an image carrier of cylindrical type, the image carrier is obtained by a known method of molding aluminum or aluminum alloy by extrusion and processing the surface. A belt form image carrier may also be used.

The charging unit is not particularly limited and known chargers may be used, such as a contact type charger using conductive or semiconductive roller, brush, film and rubber blade, scorotron charger or corotron charge making use of corona discharge, and others. Above all, the contact type charging unit is preferred from the viewpoint of excellent charge compensation capability. The charging unit usually applies DC current to the electrophotographic photosensitive material, but AC current may be further superimposed.

The exposure unit is not particularly limited for example, an optical system device, which exposes a desired image on the surface of the electrophotographic photosensitive material by using a light source such as semiconductor laser beam, LED beam, liquid crystal shutter beam or the like, or through a polygonal mirror from such light source, may be used.

The developing unit may be properly selected depending on the purpose, and, for example, a known developing unit for developing by using one-pack type developing solution or two-pack type developing solution, with or without contact, using brush and roller may be used.

The first transfer unit includes known transfer chargers such as a contact type transfer charger using member, roller, film and rubber blade, and scorotron transfer charger or corotron transfer charger making use of corona discharge. Above all, the contact type transfer charger provides excellent transfer charge compensation capability. Aside from the transfer charger, a peeling type charger may be also used.

The second transfer unit may be the same as the first transfer unit, such as a contact type transfer charger using transfer roller and others, scorotron transfer charger, and corotron transfer charger. By pressing firmly using the transfer roller of the contact type transfer charger, the image transfer stage can be maintained. Further, by pressing the transfer roller or the contact type transfer charger at the position of the roller for guiding the intermediate transfer belt, the action of moving the toner image from the intermediate transfer belt to the transfer material may be performed.

As the photo destaticizing unit, for example, a tungsten lamp or LED may be used, and the light quality used in the photo destaticizing process may include white light of tungsten lamp and red light of LED. As the irradiation light intensity in the photo destaticizing process, usually the output is set to be about several times to 30 times of the quantity of light showing the half exposure sensitivity of the electrophotographic photosensitive material.

The fixing unit is not particularly limited, and any known fixing unit may be used, such as heat roller fixing unit and oven fixing unit.

The cleaning unit is not particularly limited, and any known cleaning device may be used.

A color image forming apparatus for repeating primary transfer is shown schematically in FIG. 1. The image forming apparatus shown in FIG. 1 includes a photosensitive drum 1 as image carrier, an intermediate transfer member 2, shown as an intermediate transfer belt, a bias roller 3 as transfer electrode, a tray 4 for feeding paper as transfer material, a developing device 5 by BK (black) toner, a developing device 6 by Y (yellow) toner, a developing device 7 by M (magenta) toner, a developing device 8 by C (cyan) toner, a member cleaner 9, a peeling pawl 13, rollers 21, 23 and 24, a backup roller 22, a conductive roller 25, an electrode roller 26, a cleaning blade 31, a block of paper 41, a pickup roller 42, and feed rollers 43.

In the image forming apparatus shown in FIG. 1, the photosensitive drum 1 rotates in the direction of arrow A, and the surface of the charging device (not shown) is uniformly charged. On the charged photosensitive drum 1, an electrostatic latent image of a first color (for example, BK) is formed by an image writing device such as a laser writing device. This electrostatic latent image is developed by toner by the developing device 5, and a visible toner image T is formed. The toner image T is brought to the primary transfer unit comprising the conductive roller 25 by rotation of the photosensitive drum 1, and an electric field of reverse polarity is applied to the toner image T from the conductive roller 25. The toner image T is electrostatically adsorbed on the intermediate transfer belt 2, and the primary transfer is executed by rotation of the intermediate transfer belt 2 in the direction of arrow B.

Similarly, a toner image of a second color, a toner image of a third color, and a toner image of a fourth color are sequentially formed and overlaid on the transfer belt 2, and a multi-layer toner image is formed.

The multi-layer toner image transferred on the transfer belt 2 is brought to the secondary transfer unit comprising the bias roller 3 by rotation of the transfer belt 2. The secondary transfer unit comprises the bias roller 3 disposed at the surface side carrying the toner image of the transfer belt 2, backup roller 22 disposed to face the bias roller 3 from the back side of the transfer belt 2, and electrode roller 26 rotating in tight contact with the backup roller 22.

The paper 41 is taken out one by one from the paper block accommodated in the paper tray 4 by means of the pickup roller 42, and is fed into the space between the transfer belt 2 and bias roller 3 of the secondary transfer unit by means of the feed roller 43 at a specified timing. The fed paper 41 is conveyed under pressure between the bias roller 3 and backup roller 22, and the toner image carried on the transfer belt 2 is transferred thereon by rotation of the transfer member 2.

The paper 41 on which the toner image is transferred is peeled off from the transfer member 2 by operating the peeling pawl 13 at the retreat position until the end of primary transfer of the final toner image, and conveyed to the fixing device (not shown). The toner image is fixed by pressing and heating, and a permanent image is formed. After transfer of the multi-layer toner image onto the paper 41, the transfer belt 2 is cleaned by the cleaner 9 disposed at the downstream side of the secondary transfer unit to remove the residual toner, and is ready for next transfer. The bias roller 3 is provided so that the cleaning blade 31, made of polyurethane or the like, may be always in contact, and toner particles, paper dust, and other foreign matter sticking by transfer are removed.

In the case of transfer of a monochromatic image, the toner image T after primary transfer is immediately sent to the secondary transfer process, and is conveyed to the fixing device. But in the case of transfer of a multi-color image by combination of plural colors, the rotation of the intermediate transfer belt 2 and photosensitive drum 1 is synchronized so that the toner images of plural colors may coincide exactly in the primary transfer unit, and deviation of toner images of colors is prevented. In the secondary transfer unit, by applying a voltage of the same polarity (transfer voltage) as the polarity of the toner to the electrode roller 26 tightly contacting with the backup roller 22 disposed oppositely through the bias roller 3 and intermediate transfer belt 2, the toner image is transferred onto the paper 41 by electrostatic repulsion. Thus, the image is formed.

The intermediate transfer member 2 described herein is a seamless belt.

The process for the manufacture of polymeric seamless intermediate transfer belt (ITB) for xerographic applications is described herein. The ITB is obtained by providing a mixture of a UV curable polymer, a conductive component and a photoinitiator. The mixture is centrifugally molded in on an inner surface of a cylindrical mandrel. The UV curable polymer layer is solidified by UV radiation to form a uniform solid film. If desired, subsequent layers of UV curable polymers can be applied to the first layer to increase thickness and modify properties of the ITB.

The process includes generating at least one thin substantially uniform fluid coating on the interior of a cylindrical mandrel, solidifying the fluid coating to form a uniform solid film, and then optionally providing subsequent mixtures of the UV curable polymer. The seamless belt has a smooth outer surface whose finish is determined by the finish on the inner surface of the hollow mandrel, which is highly polished. The belt can be of any desired length, constrained only by the diameter of the mandrel. The axial dimension of the cylindrical mandrel dictates the width of the fabricated belt. That axial dimension can be configured to be multiple belt widths in size such that the fabricated belt may be sliced into multiple belts after fabrication. Uniform coating is obtained by rotating the mandrel about its axis. By this means, it is possible to fabricate a belt with varying composition and electrical properties by depositing successive layers of different materials with mixture application and centrifugal molding process. The circumference of the intermediate transfer member, especially as it is applicable to a film or a belt configuration, is, for example, from about 250 millimeters to about 2,500 millimeters, from about 1,500 millimeters to about 2,500 millimeters, or from about 2,000 millimeters to about 2,200 millimeters with a corresponding width of, for example, from about 100 millimeters to about 1,000 millimeters, from about 200 millimeters to about 500 millimeters, or from about 300 millimeters to about 400 millimeters.

Separation of the belt after coating and drying can be achieved by first depositing a release agent inside the mandrel and/or incorporating a release agent in the coating solution itself. Another way of achieving the same goal is to coat a permanent solid layer such as Teflon inside the mandrel surface. Another means to facilitate removal of the dried film from the inside of the mandrel is to take advantage of the differential thermal expansion of the mandrel and the dried film. The belt is solidified through UV curing.

The seamless ITB disclosed herein has a tunable outer surface morphology whose finish is determined by the finish on the inner surface of the cylindrical mandrel. For example, that surface is highly polished or honed or dimpled, which surface morphology might help toner cleaning and transfer efficiency. The belt can be of any desired length, constrained only by the diameter of the mandrel. The axial dimension of the cylindrical mandrel dictates the width of the fabricated belt. That axial dimension can be configured to be multiple belt widths in size such that the fabricated belt may be sliced into multiple belts after fabrication.

In centrifugal molding, a liquid mixture is deposited on an inner surface of a rotating cylinder. The cylinder is rotated slowly during deposition and then the speed of rotation is increased to form a uniform layer on the inner surface. UV radiation is then provided the cure the uniform layer. In this manner there is obtained a cylindrical molding.

The finish of the outside of the belt fabricated as described above is determined by the inside finish of the mandrel. With diamond lathing and polishing a very smooth surface of the mandrel can be obtained. The average roughness of the inside finish of the mandrel (Rₐ) is from about 0.01 microns to about 1 micron, or from about 0.03 microns to about 0.7 microns, or from about 0.05 microns to about 0.5 microns.

A UV curing lamp provides the UV radiation required to cure the layer. The UV curing process is very fast and the layer is cured quickly. Although any circumferential flow of wet layer is minimized by the centrifugal forces of the rotating mandrel, quick curing prevents any residual sagging in the wet layer. Thus under the best circumstances a belt could be formed in just one single pass. However, multiple passes can be implemented to obtain the proper characteristics of the intermediate transfer belt. The rotating speed is not critical, but can be selected from a broad range, such as from about 100 rpm to about 1,500 rpm, or from about 200 rpm to about 1200, or from about 300 rpm to about 800 rpm.

The liquid coating composition can include one or more UV curable polymers including, but not limited to, monomeric acrylates, oligomeric acrylates and/or combinations thereof.

In embodiments, monomeric acrylates can function as co-reactants and/or diluents in the composition to adjust system viscosity. The monomeric acrylates can include, for example, trimethylolpropane triacrylates, hexandiol diacrylates, tripropyleneglycol diacrylates, dipropyleneglycol diacrylates, and the like and mixtures thereof.

In embodiments, oligomeric acrylates can be viscous liquid polymers with the molecular weight ranging from several hundreds to several thousands or higher. The oligomeric acrylates can include, for example, urethane acrylates, polyester acrylates, epoxy acrylates, polyether acrylates, and olefin acrylates such as polybutadiene acrylates, and the like and mixtures thereof.

The liquid coating composition can also include photoinitiators, such as, for example, a photoinitiator for a surface curing of the UV curable polymer, a photoinitiator for a bulk curing through the UV curable polymer, and combinations thereof. In an exemplary embodiment, combined photoinitiators can be used to initiate the curing process. Examples of the photoinitiators can include, but are not limited to, acyl phosphines, α-hydroxyketones, benzyl ketals, α-aminoketones, and mixtures thereof.

In embodiments, the photoinitiators can be in a form of, for example, crystalline powders and/or a liquid. The photoinitiators can be present in an amount sufficient to initiate the curing process of the UV curable polymer(s). For example, the photoinitiators can be present in an amount ranging from about 0.5% to about 10%, or from about 1% to about 7%, or from about 2% to about 5% by weight of the UV curable polymer(s).

In embodiments, the liquid coating composition can be heterogeneous and can include UV curable polymer(s) and additional fillers dispersed in the composition. The coating layer formed on the inside of the mandrel from the heterogeneous coating composition can be a heterogeneous layer, for example a heterogeneous ITB, including conductive fillers dispersed in UV cured polymer resins. The conductive fillers can be conductive and/or semi-conductive.

Examples of conductive fillers dispersed in the UV curable polymer include carbon blacks such as carbon black, graphite, acetylene black, fluorinated carbon black, and the like; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof, Certain polymers such as polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene and mixture thereof can be used as conductive fillers. The conductive filler may be present in an amount of from about 0.1 part by weight to about 50 parts by weight, or from about 3 parts by weight to about 40 parts by weight, or from about 5 to about 20 parts by weight of total solids of the intermediate transfer belt. These ranges apply for either the single layer or multi-layer applications. A variety of conductive components such as conductive particles can be used in embodiments described herein.

One embodiment uses carbon nanotubes (CNTs). Carbon nanotubes are more conductive, and only very small amount, such as from about 0.1 weight percent to about 2.0 weight percent, or from about 0.3 weight percent to about 1.5 weight percent, or from about 0.5 weight percent to about 1.0 weight percent of the CNTs are needed to achieve a desired resistivity for ITB. Thus, carbon nanotubes are extremely suitable for UV cured layers since when incorporated at such a small amount, UV light easily penetrates across the layer for a complete cure. In comparison, carbon black requires high loading of about 10 weight percent to about 20 weight percent to achieve comparable resistivity. The carbon black-filled layer prevents UV light from penetrating deep into the layer, thus complete cure is difficult.

As used herein and unless otherwise specified, the term “carbon nanotube” or CNT refers to an elongated carbon material that has at least one minor dimension (for example, width or diameter of up to 100 nanometers). In various embodiments, the CNT can have an average diameter ranging from about 1 nm to about 100 nm, or in some cases, from about 5 nm to about 50 nm, or from about 10 nm to about 30 nm. The carbon nanotubes have an aspect ratio of at least 10, or from about 10 to about 1000, or from about 10 to about 5000. The aspect ratio is defined as the length to diameter ratio.

In various embodiments, the carbon nanotubes can include, but are not limited to, carbon nanoshafts, carbon nanopillars, carbon nanowires, carbon nanorods, and carbon nanoneedles and their various functionalized and derivatized fibril forms, which include carbon nanofibers with exemplary forms of thread, yarn, fabrics, etc. In one embodiment, the CNTs can be considered as one atom thick layers of graphite, called graphene sheets, rolled up into nanometer-sized cylinders, tubes, or other shapes.

In various embodiments, the carbon nanotubes or CNTs can include modified carbon nanotubes from all possible carbon nanotubes described above and their combinations. The modification of the carbon nanotubes can include a physical and/or a chemical modification.

In various embodiments, the carbon nanotubes or CNTs can include single wall carbon nanotubes (SWCNTs), multi-wall carbon nanotubes (MWCNTs), and their various functionalized and derivatized fibril forms such as carbon nanofibers. The CNTs can be formed of conductive or semi-conductive materials. In some embodiments, the CNTs can be obtained in low and/or high purity dried paper forms or can be purchased in various solutions. In other embodiments, the CNTs can be available in the as-processed unpurified condition, where a purification process can be subsequently carried out.

In order to achieve high conductivity and high transparency, CNTs need to be exfoliated and de-bundled. Zyvex Performance Materials (Columbus, Ohio) has developed a proprietary technology to exfoliate and de-bundle CNT, where CNT is dispersed with the aid of a dispersant, which structure is disclosed at least one of (J. Am. Chem. Soc., 124, 9034, 2002):

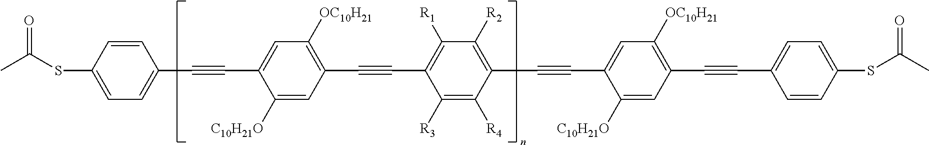

wherein when R₁ and R₄ are hydrogen, R₂ and R₃ are OC₁₀H₂₁; or wherein R₁, R₂, R₃ and R₄ are a halide such as a fluoride; or wherein when R₁ and R₄ are hydrogen, R₂ and R₃ are

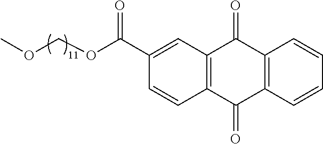

wherein n represents the number of repeating segments, and generally wherein it is envisioned that each R substituent may be alkyl, alkoxy, or aryl, however, it is not desired to be limited by theory, and

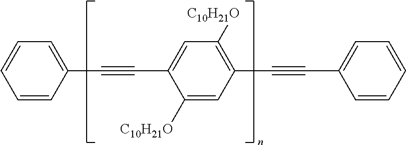

wherein n represents the number of repeating segments.

The weight ratio of the CNT to the dispersant is, for example, from about 95/5 to about 60/40, or from about 90/10 to about 70/30, or 83.3/16.7. Specific examples of the CNT dispersion comprise a multi-walled nanotube (MWNT)/dispersant selected in a ratio of about 83.3/16.7 in methylene chloride, about 0.78 weight percent solids, available from Zyvex Performance Materials.

Carbon nanotubes (CNTs) are known and generally refer to allotropes of carbon with a cylindrical nanostructure. Nanotubes can be constructed with a length-to-diameter ratio of up to 28,000,000:1.

Nanotubes are members of the fullerene structural family, which also includes spherical shaped buckyballs. The ends of a nanotube might be capped with a hemisphere of the buckyball structure. Their name is derived from their size since the diameter of a nanotube is, for example, on the order of a few nanometers (approximately 1/50,000th of the width of a human hair), while they can be up to several millimeters in length. Nanotubes are categorized as single-walled nanotubes (SWNTs) and multi-walled nanotubes (MWNTs).

The conductivity of carbon black is primarily dependent on surface area and its structure. Generally, the higher the surface area and the higher the structure, the more conductive the carbon black. Surface area is measured by the B.E.T. nitrogen surface area per unit weight of carbon black, and is the measurement of the primary particle size. The surface area of the carbon black described herein is from about 460 m²/g to about 35 m²/g. Structure is a complex property that refers to the morphology of the primary aggregates of carbon black. It is a measure of both the number of primary particles comprising primary aggregates, and the manner in which they are “fused” together. High structure carbon blacks are characterized by aggregates comprised of many primary particles with considerable “branching” and “chaining”, while low structure carbon blacks are characterized by compact aggregates comprised of fewer primary particles. Structure is measured by dibutyl phthalate (DBP) absorption by the voids within carbon blacks. The higher the structure, the more the voids, and the higher the DBP absorption.

Examples of carbon blacks selected as the conductive component for the ITM include VULCAN® carbon blacks, REGAL® carbon blacks, MONARCH® carbon blacks and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); Channel carbon blacks available from Evonik-Degussa; Special Black 4 (B.E.T. surface area=180 m²/g, DBP absorption=1.8 ml/g, primary particle diameter=25 nanometers), Special Black 5 (B.E.T. surface area=240 m²/g, DBP absorption=1.41 ml/g, primary particle diameter=20 nanometers), Color Black FW1 (B.E.T. surface area=320 m²/g, DBP absorption=2.89 ml/g, primary particle diameter=13 nanometers), Color Black FW2 (B.E.T. surface area=460 m²/g, DBP absorption=4.82 ml/g, primary particle diameter=13 nanometers), and Color Black FW200 (B.E.T. surface area=460 m²/g, DBP absorption=4.6 ml/g, primary particle diameter=13 nanometers).

Further examples of conductive fillers include doped metal oxides. Doped metal oxides include antimony doped tin oxide, aluminum doped zinc oxide, antimony doped titanium dioxide, similar doped metal oxides, and mixtures thereof.

Suitable antimony doped tin oxides include those antimony doped tin oxides coated on an inert core particle (e.g., ZELEC®ECP-S, M and T) and those antimony doped tin oxides without a core particle (e.g., ZELEC®ECP-3005-XC and ZELEC®ECP-3010-XC, ZELEC® is a trademark of DuPont Chemicals Jackson Laboratories, Deepwater, N.J.). The core particle may be mica, TiO₂ or acicular particles having a hollow or a solid core.

Examples of the metal oxide core include tin oxide, antimony-doped tin oxide, indium oxide, indium-doped tin oxide, zinc oxide, titanium oxide, etc. In an embodiment, the electrically conductive metal oxide core is antimony doped tin oxide. Suitable antimony doped tin oxide examples are T-1 from Mitsubishi Chemical, or ZELEC® ECP-3005-XC and ZELEC® ECP-3010-XC from of DuPont Chemicals.

Alternatively, the liquid coating composition can be homogeneous and can include UV curable polymers and conductive species that are soluble, compatible, or miscible with the UV curable polymers. The homogeneous liquid composition is provided by coating or extrusion on the inside of the mandrel and can form a UV cured homogeneous ITB coating layer. In embodiments, the ITB coating layer can have uniform electrical resistivities in bulk and/or on the surfaces.

The conductive species used in a homogeneous coating composition can include, but are not limited to, salts of organic sulfonic acid such as sodium sec-alkane sulfonate (ARMOSTAT® 3002 from AKZO Nobel) and sodium C10-C18-alkane sulfonate (HOSTASTAT® HS1FF from Clariant), esters of phosphoric acid such as STEPFAC® 8180, 8181, 8182 (phosphate esters of alkyl polyethoxyethanol), 8170, 8171, 8172, 8173, 8175 (phosphate esters of alkylphenoxy polyethoxyethanol), POLYSTEP® P-11, P-12, P-13 (phosphate esters of tridecyl alcohol ethoxylates), P-31, P-32, P-33, P-34, P-35 (phosphate esters of alkyl phenol ethoxylates), all available from Stepan Corporation, esters of fatty acids such as HOSTASTAT® FE20liq from Clariant (Glycerol fatty acid ester), ammonium or phosphonium salts such as benzalkonium chloride, N-benzyl-2-(2,6-dimethylphenylamino)-N,N-diethyl-2-oxoethanaminium benzoate, cocamidopropyl betaine, hexadecyltrimethylammonium bromide, methyltrioctylammonium chloride, and tricaprylylmethylammonium chloride, behentrimonium chloride (docosyltrimethylammonium chloride), tetradecyl(trihexyl)phosphonium chloride, tetradecyl(trihexyl)phosphonium decanoate, trihexyl(tetradecyl)phosphonium bis 2,4,4-trimethylpentylphosphinate, tetradecyl(trihexyl)phosphonium dicyanamide, triisobutyl(methyl)phosphonium tosylate, tetradecyl(trihexyl)phosphonium bistriflamide, tetradecyl(trihexyl)phosphonium hexafluorophosphate, tetradecyl(trihexyl)phosphonium tetrafluoroborate, ethyl tri(butyl)phosphonium diethylphosphate, etc.

The homogeneous composition can be prepared by mixing the conductive species in a liquid UV curable polymer to form a solution, and then adding photoinitiators into the solution. The final homogeneous ITB coating layer can include conductive species ranging from about 1 weight percent to about 40 weight percent, or ranging from about 5 weight percent to about 30 weight percent, or ranging from about 10 weight percent to about 20 weight percent of the total homogeneous ITB layer.

The volume (or bulk) resistivity and the surface resistivity of the final ITB coating layer can be uniform with minimal variation. For example, a maximum value of volume resistivity can be within the range of 1 to 10 times the minimum value, and a maximum value of surface resistivity can be within the range of 1 to 100 times the minimum value.

In embodiments, the heterogeneous coating composition can be prepared by ball milling the conductive particles in a liquid UV curable polymer, and then adding corresponding photoinitiators into the milled dispersion.

The formed ITB can have a surface resistivity ranging from about 10⁸ ohms/sq to about 10¹³ ohms/sq, or from about 10⁹ ohms/sq to about 10¹² ohms/sq, or from about 10¹⁰ ohms/sq to about 10¹¹ ohms/sq. In embodiments, the formed ITB can have a mechanical Young's modulus ranging from about 500 MPa to about 10,000 MPa, or from about 1,000 MPa to about 5,000 MPa, or from about 1,500 MPa to about 3,000 MPa. In embodiments, the ITB is seamless and the ITB has a belt width ranging from about 100 millimeters to about 1,000 millimeters and a circumference ranging from about 250 millimeters to about 2,500 millimeters although any width and length is possible depending on the mandrel. In embodiments, the ITB has a total thickness of from about 30 microns to about 500 microns.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

A carbon nanotube-based dispersion was obtained from Zyvex Performance Materials (Columbus, Ohio). The carbon nanotube-based dispersion contained multi-walled carbon nanotubes (MWNT) mixed with a dispersant in a solvent of methylene chloride. In this carbon nanotube-based dispersion, MWNT/dispersant had a ratio of 83/17 by weight and the dispersion had solids (including the MWNTs and the dispersant) in an amount of about 78% by weight. The dispersant can be represented by

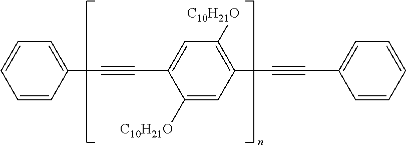

where n is from about 10 to about 150. About 100 grams of the above nanotube-based dispersion was mixed with (1) about 111.8 grams of the aromatic urethane acrylate, (2) about 13 grams of the acrylate monomer, and (3) about 4.4 grams of the photoinitiator.

In this mixture, the aromatic urethane acrylate used was commercially available as SARTOMER® CN2901 of urethane triacrylate oligomer (Tg=35° C.) from Sartomer (Exton, Pa.). The acrylate monomer used was commercially available as LAROMER® TMPTA (trimethylolpropane triacrylate) from BASF (Florham Park, N.J.). The photoinitiator used was commercially available as IRGACURE® 651 (α,α-dimethoxy-α-phenylacetophenone) from Ciba Specialty Chemicals (Tarrytown, N.Y.).

A uniform liquid dispersion was formed by ball milling the above mixture with 2 millimeter stainless shot with an Attritor for 1 hour. The uniform liquid dispersion was then coated on a glass plate using a draw bar coating method, and subsequently cured using a Hanovia UV instrument (Fort Washington, Pa.) for about 40 seconds at a wavelength of about 325 nanometers (125 watts). The film was then released from the glass plate having a thickness of about 100 microns.

The above ITB film of Example 1 was measured for surface resistivity (averaging four to six measurements at varying spots, 72° F./65 percent room humidity) using a High Resistivity Meter (Hiresta-Up MCP-HT450 available from Mitsubishi Chemical Corp.). The surface resistivity was about 2.4×10⁹ ohms/sq, within the functional range of an ITB of from about 10⁹ to about 10¹³ ohms/sq.

The above ITB film of Example 1 was measured for Young's modulus following the ASTM D882-97 process. A sample (0.5 inch×12 inch) from Example 1 was placed in the measurement apparatus, the Instron Tensile Tester, and then elongated at a constant pull rate until breaking. The instrument recorded the resulting load versus sample elongation. The modulus was calculated by taking any point tangential to the initial linear portion of this curve and dividing the tensile stress by the corresponding strain. The tensile stress was given by load divided by the average cross sectional area of the test sample.

The Young's modulus of the ITB film of Example 1 was measured to be about 2,000 MPa, within the reported modulus range of the thermoplastic ITBs on the market (from about 1,000 to about 3,500 MPa). Examples of these thermoplastic ITBs for comparison are polyester/carbon black ITB (Young's modulus of about 1,200 MPa), polyamide/carbon black ITB (Young's modulus of about 1,100 MPa), and polyimide/polyaniline ITB (Young's modulus of about 3,500 MPa).

### Example 2

About 10 grams of STEPFAC® 8180, phosphate esters of alkyl polyethoxyethanol (Stepan Corporation, Northfield, Ill.) was mixed with about 76 grams of SARTOMER® CN2901, urethane triacrylate oligomer (T_{g}=35° C., Sartomer, Exton, Pa.) and about 10 grams of LAROMER® TMPTA, trimethylolpropane triacrylate monomer (BASF, Florham Park, N.J.). About 4 grams of IRGACURE® 651, α,α-dimethoxy-α-phenylacetophenone photoinitiator (Ciba Specialty Chemicals, Tarrytown, N.Y.) was added to the acrylate and conductive species mixture to form a coating solution.

The coating was then coated on a glass plate using a draw bar coating method, and subsequently cured using a Hanovia UV instrument (Fort Washington, Pa.) for about 40 seconds at a wavelength of about 325 nanometers (about 125 watts). The UV cured composite film was then released from the glass plate and had a thickness of about 100 microns. The UV cured composite film was substantially clear with no phase separation.

The ITB member of Example 2 was measured for surface resistivity (averaging four to six measurements at varying spots, 72° F./65% room humidity) using a High Resistivity Meter (Hiresta-Up MCP-HT450 available from Mitsubishi Chemical Corp.). The surface resistivity was about 3.7×10¹⁰ ohm/square, within the functional range of an ITB of from about 10⁹ to about 10¹³ ohm/square.

The Young's modulus of the ITB member of Example 2 was measured to be about 1,600 MPa, within the reported modulus range of the thermoplastic ITBs on the market (from about 1,000 to about 3,500 MPa).

The disclosed UV cured ITB exhibited comparable or higher modulus than most thermoplastic ITBs on the market (mainly for less costly machines) such as polyphenylene sulfide (comparable), polyester, polyamide and PVDF ITB devices. When compared with the polyimide ITB (mainly for higher cost machines), the disclosed UV cured ITB exhibited lower modulus, but comparable hardness.

The feasibility of the process was demonstrated. The above formulation was coated on the inside of a 200 mm glass cylinder while the cylinder was rotating at 100 rpm (simulating centrifugal molding process), and the inside coated cylinder was cured using an IR lamp for 1 hour. The liquid coating did solidify, and was released from the cylinder to form an 80 μm seamless belt. Since the curing energy did not match, the IR cured belt has much lower modulus of about 500 MPa (IR, 1 hour curing). In contrast, the UV cured belt has a modulus of about 2,000 MPa (UV, 40 seconds). The surface of the seamless ITB prepared using the simulated IR curing was shiny and smooth due to the smooth inside surface of the cylinder.

The feasibility of making UV cured seamless ITB using centrifugal molding on the inside of a rotating cylinder, the liquid coating solidifying via UV curing, and then releasing from the cylinder has been demonstrated. Thus, a functional UV cured seamless ITB can be obtained.

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled the in the art which are also encompassed by the following claims.

What is claimed is:

1. A method of forming an intermediate transfer member suitable for use with an image forming system, comprising:
providing a mixture of an ultra violet (UV) curable polymer and a conductive component, and a photoinitiator;
centrifugally molding the mixture onto an inner surface of a rotating cylindrical mandrel;
curing the UV polymer with ultra violet energy; and
removing the cured UV polymer from the cylindrical rotatable mold.

2. The method of claim 1 wherein the conductive component is selected from the group consisting of carbon black, carbon nanotube, fullerene, potassium titanate, graphite, acetylene black, fluorinated carbon black, metal oxides, doped metal oxides polyaniline, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts, and mixtures thereof.

3. The method of claim 1, wherein the UV curable polymer comprises a material selected from the group consisting of a monomeric acrylate, an oligomeric acrylate and a combination thereof.

4. The method of claim 3, wherein the wherein the monomeric acrylate is selected from the group consisting of trimethylolpropane triacrylate, hexandiol diacrylate, tripropyleneglycol diacrylate, dipropyleneglycol diacrylate, and mixtures thereof.

5. The method of claim 3, wherein the oligomeric acrylate is selected from the group consisting of urethane acrylate, polyester acrylate, epoxy acrylate, polyether acrylate, olefin acrylate, and mixtures thereof.

6. The method of claim 1, wherein the photoinitiator is selected from the group consisting of acyl phosphines, α-hydroxyketones, benzyl ketals, α-aminoketones, and mixtures thereof.

7. The method of claim 1 wherein the mandrel is rotated at a speed of from about 100 rpm to about 1,500 rpm.

8. The method of claim 1 further comprising:
treating the inside of the cylindrical mandrel with a release agent prior to the centrifugal molding.

9. The method of claim 1 further wherein the inner surface of the mandrel has an average roughness of from about 0.01 microns to about 1.0 microns

10. The method of claim 1 wherein the conductive particles comprise carbon nanotubes and a dispersant comprising a formula represented by at least one of: 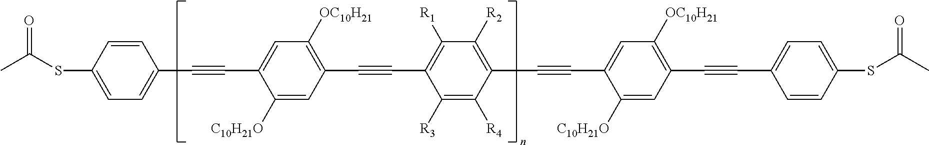
wherein when R₁ and R₄ are hydrogen, R₂ and R₃ are OC₁₀H₂₁; wherein R₁, R₂, R₃ and R₄ are a halide; or wherein when R₁ and R₄ are hydrogen, R₂ and R₃ are 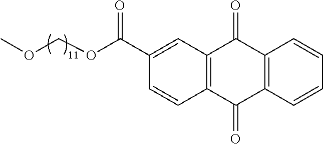
wherein n represents the number of repeating segments, and 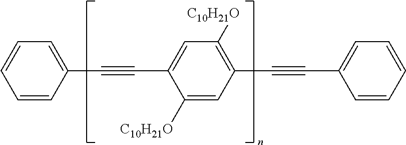
wherein n represents the number of repeating segments, and wherein each n is from 1 to about 225.

11. The method of claim 10 wherein the carbon nanotubes comprise from about 0.1 weight percent to about 2.0 weight percent of the mixture.

12. A method of forming a seamless transfer member suitable for use with an image forming system, comprising:
providing a mixture of an ultra violet (UV) curable polymer, conductive particles, and a photoinitiator;
centrifugally molding the mixture on an inner surface of a rotating mandrel wherein the inner surface of the mandrel has a average roughness of from about 0.01 microns to about 1.0 microns;
curing the mixture with ultraviolet energy; and
removing the cured mixture from the cylindrical rotatable mold.

13. The method of claim 12, wherein the conductive particles are selected from the group consisting of carbon black, carbon nanotube, fullerene, potassium titanate, graphite, acetylene black, fluorinated carbon black, metal oxides, doped metal oxides polyaniline, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts, and mixtures thereof.

14. The method of claim 12, wherein the UV curable polymer comprises a material selected from the group consisting of a monomeric acrylate, an oligomeric acrylate and a combination thereof.

15. The method of claim 12, wherein the wherein the monomeric acrylate is selected from the group consisting of trimethylolpropane triacrylate, hexandiol diacrylate, tripropyleneglycol diacrylate, dipropyleneglycol diacrylate, and mixtures thereof.

16. The method of claim 15, wherein the oligomeric acrylate is selected from the group consisting of urethane acrylate, polyester acrylate, epoxy acrylate, polyether acrylate, olefin acrylate, and mixtures thereof.

17. The method of claim 15, wherein the photoinitiator is selected from the group consisting of acyl phosphines, α-hydroxyketones, benzyl ketals, α-aminoketones, and mixtures thereof.

18. The method of claim 1 wherein the mandrel is rotated at a speed of from about 100 rpm to about 1,500 rpm.

19. A method of forming a seamless transfer member suitable for use with an image forming system, comprising:
providing a mixture of an ultra violet (UV) curable polymer, carbon nanotubes and a photoinitiator;
centrifugally molding the mixture on an inner surface of a rotating mandrel at a speed of from about 100 rpm to about 1500 rpm wherein the inner surface of the mandrel has a average roughness of from about 0.01 microns to about 1.0 microns;
curing the mixture with ultraviolet energy; and
removing the cured mixture from the cylindrical rotatable mold.

20. The method of claim 19 wherein the carbon nanotubes comprise from about 0.1 weight percent to about 2.0 weight percent of the mixture.
